(19) United States
(12) Patent Application Publication
(10) Pub. No.: US 2007/0103117 A1
(43) Pub. Date: May 10, 2007

(54) Charging method and charging units

(76) Inventor: Frank Burghardt, 13125 BERLIN GERMANY (DE)

Correspondence Address: Mark J Henry;Staas & Halsey, 1201 New York Avenue N W, 7th Floor, Washington, DC, 20005, US

(21) Appl. No.: 10/571,917

(22) PCT Filed: Aug. 20, 2004
(86) PCT No.: PCT/EP04/51868

§ 371 Date: Mar. 15, 2006

(30) Foreign Application Priority Data
Sep. 15, 2003 (DE) 103-42-558.6

(51) Int. Cl. H02J 7/00

(52) U.S. Cl. 320/119

(57) ABSTRACT

A method involves storing a change data record with a change data in a network element of a data transmission network; transmitting a service request message for the use of a service by the user; allocating a service termination data for the user according to the service request message; changing the termination date according to the use of the service in the network element, and; determining the end of the service according to the service termination date in the network element. The method is simple and offers numerous advantages.

### CROSS REFERENCE TO RELATED APPLICATIONS

This application is based on and hereby claims priority to PCT Application No. PCT/EP2004/051868 filed on Aug. 20, 2004 and German Application No. 10342558.6 filed on Sep. 15, 2003, the contents of which are hereby incorporated by reference.

### BACKGROUND OF THE INVENTION

The invention relates to a method for charging in which the following procedural steps are executed:
Storing, in a network element of a data transmission network, a charge-data record having charge data indicating the account balance of a charge account of a user who transmits useful data over said data transmission network,
transmitting a service request message for the use of a service by the user,
depending on the service request message, allocating service termination data to the user, with said service termination data setting a limit on the use of the service and with the value of the charge data being changed, and
changing the termination data depending on the use of the service.

The data transmission network is in particular a data packet transmission network, in particular the internet or a 3GPP (Third Generation Partnership Program) network, in particular a UMTS (Universal Mobile Telecommunication System) network. A destination address, inter alia, is stored in a data packet header. The useful data is in a data packet stub.

A charging method is explained in, for example, the 3GPP Group's standards published, for example, on the internet at the address ftp://ftp.3gpp.org/specs/archive, in particular in the standards:
3GPP TS 32.200, 3GPP, Technical Specification Group Service and System Aspects, Telecommunication Management, Charging Management, Charging Principles,
3GPP TS 32.225, 3GPP, Technical Specification Group Service and System Aspects, Telecommunication Management, Charging Management, Charging Data Description for the IP Multimedia Subsystems (IMS).

The Diameter Base Protocol, which is an expansion of the RADIUS (Remote Authentication Dial In User Service) protocol and is abbreviated below to Diameter Protocol, is proposed as a suitable protocol. Said Diameter Protocol is still undergoing de-facto standardizing and is available in provisional form or, as the case may be, will later be available as a draft on the internet page (www.ietf.org) of the IETF (Internet Engineering Task Force). Both protocols are what are termed AAA (Authentication, Authorization, Accounting) protocols.

### SUMMARY OF THE INVENTION

One possible object of the invention is to disclose a simple method for charging which can in particular be implemented using simply structured programs and which in particular uses existing standards or, as the case may be, standards currently undoing standardizing. Another possible objectis to use simply structured charging units.

The inventors propose that the following procedural steps are executed in addition to those cited at the beginning:
Changing the termination data, depending on the use of the service, in the network element, which also assumes the function of account managing, and not, as previously, in another network element, and
determining the end of the service likewise in the network element depending on the service termination data.

The method proceeds in particular from the following considerations. In second-generation mobile radio networks, which is to say, in particular, in the European GSM (Global System Mobile) network, authorized mobile radio customers can use different services, for example voice services or SMS (Short Message Service), without there being a fixed contractual relationship between the operator of the mobile radio network and the customer if payment for the required service is guaranteed before it is performed. The amount can be directly debited from the customer's credit account or reserved. The costs incurred can be monitored at any time by what is termed the prepaid customer. However, budget controlling takes place in another network element serving to provide credit account management.

In second-generation mobile radio networks the services offered are charged for either by time, for example in the case of voice telephony, or by events, for example in the case of SMS. Packet services, for example MMS (Multimedia Message Service) in 2.5th-generation mobile radio networks, can also be invoiced by volume, for example in kilobytes, with in particular the GPRS (Global Packet Radio Service) service being used.

3rd-generation mobile radio networks, which is to say in particular UMTS (Universal Mobile Telecommunication Service) networks, are designed not only for voice and variable data streams but also allow customers to use multimedia services. Charging for the use of multimedia services is highly complex and poses a hitherto unsatisfactorily resolved problem. There are supposed to be different charging models for online charging and offline charging. However, in particular time-based charging is at present only possible in 3rd-generation mobile radio networks at a very high technical expenditure so that a simple and economical method needs to be found. A major feature of a method of said type should be monitoring of the budget allowed, which is to say of the credit at the time a service is performed. Said feature is referred to also as budget controlling and can be implemented in different network elements, in particular in the IP (Internet Protocol) Multimedia Subsystem (IMS). In contrast to this, no budget controlling is required for offline charging.

The charging method has hitherto had to be conveyed to the network elements by charging messages, for example via an address of the Event Charging Function (ECF) contained in the OCS or, as the case may be, CCF, which function is part of what is termed an OCS (Online Charging System).

In contrast to this, the method provides the possibility of leaving the choice of charging method to the OCS or, as the case may be, a CCF (Charging Collection Function) with the use of offline charging.

In particular the Diameter Protocol can be considered as a suitable protocol for the authorizing message and charging message. However, only the accounting part of said protocol has hitherto been used in connection with charging. Numerous advantages can, though, be gained from, for instance, including the authorizing part in charging. In particular it is possible for charging to be stopped from a charging server. The accounting part has hitherto not offered a possibility of said type. The authorizing part can be embedded in the accounting part. The accounting part of, for example, the Diameter Protocol can alternatively be embedded in said protocol's authorizing part.

Combining account management and budget controlling, in particular using the Diameter Protocol, gives rise to the following advantages:
The core network elements involved will no longer need to know the charging method. The choice of charging method is left to the charging function, which is to say, for example, to the OCS or CCF.
A high degree of time accuracy can be achieved for the time-based charging methods thanks to the spatial or, as the case may be, topological proximity of the network elements to the OCS or, as the case may be, CCF.
There being no additional exchange of reserving messages over the network, the granularity of reserving, which is to say the time interval or, as the case may be, volume interval, can be as small as may be required without excessively influencing network performance.
A significant reduction in implementation costs in the network element and in the OCS/CCF.
Increased reliability due to the simplified methods.
Standardizing of the protocols for the online and offline charging method.
The method is independent of the access network, for example GPRS, UMTS, Bluetooth, or WLAN IEEE 802.11.
The Diameter Base Protocol does not have to be expanded, although it can be. The protocol can be reduced to just a few messages, thereby allowing commercially available network nodes to be used for different charging methods.
New charging methods can be introduced in a simple manner since only changes in the OCS/CCF are required.

In a development of the method an authorizing message is used to prepare for charging or on termination of charging. The authorizing messages are alternatively used both for preparing for charging and on termination of authorizing.

In another development the authorizing message contains a user identifier indicating the user of the data transmission. The user's authorization to transmit data is checked as a function of said user identifier. A type of charging and/or of invoicing is furthermore selected based on the authorizing message and/or depending on its content.

In a next development a charging amount or charging time is reserved based on the authorizing message and/or depending on its content. A data record for charging is additionally or alternatively generated when the authorizing message is being processed. The authorizing message is hence employed with an unchanged format for additional purposes compared to its previous use.

In another development the authorizing message is transmitted prior to the completion of preparation of data transmission so that a reliable method for preventing misuse is provided. The authorizing message is alternatively transmitted after completion of preparation of data transmission so that useful data, for example voice data and/or video data, can be transmitted quickly.

In a development the authorizing message complies with the specifications of the Diameter Protocol or of a protocol based thereon. The authorizing message is in particular processed according to the Diameter Protocol or a protocol based thereon. The specific structure of the authorizing message is not specified in the Diameter Protocol and depends on the relevant application.

In a development the authorizing message employed on terminating is a termination message resulting in terminating of the useful data transmission, being in particular the abort-session-request message of the Diameter Protocol or of a protocol based thereon.

In an alternative development the service request message contains a user identifier indicating the user of the data transmission. The user's authorization to transmit data is checked as a function of said user identifier so that a separate authorizing message will not have to be sent for said purpose. A type of charging and/or of invoicing is additionally selected in particular according to the actual purpose of the charging message.

Charging is in another development online charging that is able to influence the transmission of useful data. Charging is monitored in a service-performing computer provided in addition to a service-performing computer that controls the transmission of data.

In another development the same service request messages are transmitted for online charging and for offline charging, in particular messages having the same message identifier. An account request message according to the Diameter Protocol is preferably used, with the same Account-Record Type, in particular an EVENT_RECORD, preferably being used in both messages. The result will be a simple method wherein as far as possible the same messages are used for a plurality of charging methods. The charging method does not have to be known or determined in the control computer.

The inventors also propose a server-charging unit and a client-charging unit, in particular having units for executing the procedural steps of the method or one of its developments. The above-cited technical effects thus apply also to the charging units.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows functional units for a transmission of signaling data and for charging,

FIG. 2 shows the flow of messages for an SIP session with online charging, with authorizing prior to setting up of the possibility of transmitting data, and with releasing by a terminal,

FIG. 3 shows the flow of messages for an SIP session with online charging, with authorizing after setting up of the possibility of transmitting data, and with releasing by a charging computer,

FIG. 4 shows a part of the flow of messages in an SIP session with online charging, with releasing by a control unit for controlling the transmission of data,

FIG. 5 shows the flow of messages in an SIP session with offline charging,

FIG. 6 shows functional units of a server unit that serves charging purposes, and

FIG. 7 shows functional units of a client unit that serves charging purposes.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

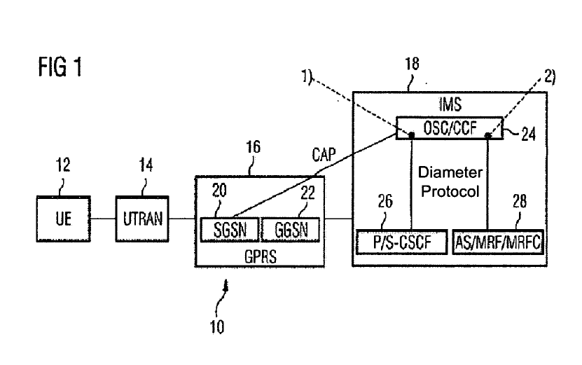

FIG. 1 shows functional units of a data transmission network 10 for a transmission of signaling data and for charging. A terminal 12 is connected via an access network 14. Said access network 14 leads via a GPRS (Global Packet Radio Service) unit 16 to an IP Multimedia Subsystem (IMS) 18.

The GPRS unit contains an SGSN (Serving GPRS Service Node) unit 20 and a GGSN (Gateway GPRS Service Node) unit 22 whose functions are explained in particular in the 3GPP TS 32.200 standard.

The subsystem 18 contains an OCS/CCF unit or, as the case may be, an authorizing/charging unit 24 as well as a control unit 26, in particular a P-CSCF (Proxy Call Session Control Function) or S-CSCF (Serving Call Session Control Function). Said subsystem 18 also contains an application server 28, for example a video server, an MRF (Media Resource Function) unit or, as the case may be, an MRFC (Media Resource Function Controller) unit.

So that both the S-CSCF 26 and other network elements can be kept as simple as possible, the budget controlling function BC is assigned:

1. to the Online Charging System (OCS) and

2. to the Charging Collection Function (CCF) of the Offline Charging System.

The OCS and CCF are not necessarily assigned to a common network element. As a result of the further development of charging methods, which is to say convergent charging, offline charging is performed similarly to online charging.

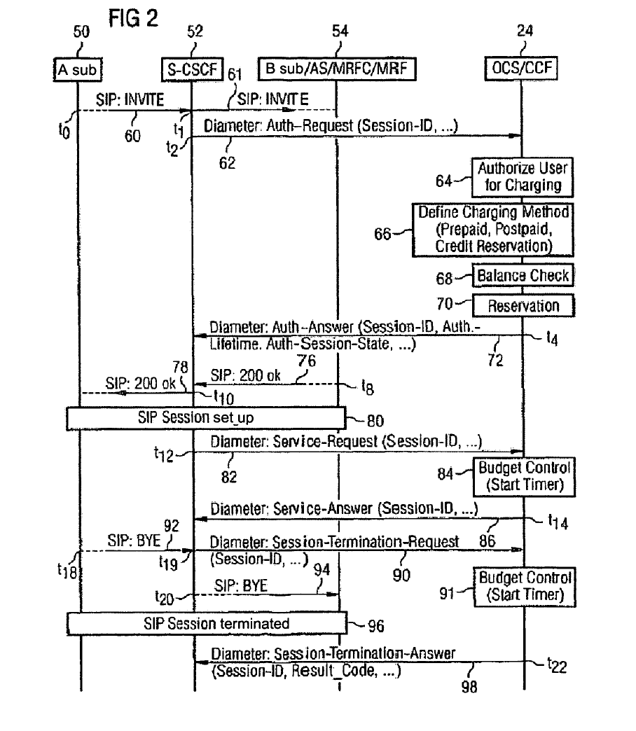

The Diameter Base Protocol is employed between the OCS/CCF and the control unit 26 or, as the case may be, the unit 28 in the manner explained below with the aid of FIGS. 2 to 5. The standardized interfaces Ro (online) and Rf (offline) are therefore already more similar to each other than originally provided in the standard.

The messages employed in the following scenarios can be mapped by the following commands of the Diameter Base Protocol:

| Messages in the scenarios, | Diameter Base | |
|---|---|---|
| in particular as per FIGS. 2 | Protocol | Diameter Base Protocol |
| to 5 | Authorizing | Accounting |
| Auth-Request | AAR; RAR | |
| Auth-Answer | AAA, RAA | |
| Service request | AAR | ACR |
| Service-Answer | AAA | ACA |
| Session-Termination- | STR | |
| Request | | |
| Session-Termination-Answer | STA | |
| Abort-Session-Request | ASR | |
| Abort-Session-Answer | ASA | |

The following applies to all scenarios:
The budget controlling function BC is sited on the OCS and CCF.
The authorizing protocol of the Diameter Protocol is used for the time-based charging of multimedia services.
The authorizing protocol is used in combination with the accounting protocol (Event_Method). Originally independent parts of the Diameter Base Protocol are thus used for charging for multimedia services with optional credit reserving, in particular according to the Diameter expansion for the credit controlling of applications (Credit Control Applications).
Mapping specifications for controlling an SIP session using Diameter messages are indicated.

In particular the SIP messages are not shown in the following with all data fields and in full detail. Nor are the attribute-value pairs of the messages of the Diameter Base Protocol (DBP) explained in full.

FIG. 2 shows the flow of messages for an SIP session with online charging (prepaid), with authorizing prior to setting up of the possibility of transmitting data, and with releasing by a terminal. An instance of prepaid charging is explained. The timers for waiting for messages are not shown.

FIG. 2 shows a terminal 50 of an A subscriber, a connection control unit 52, for example an S-CSCF (Call State Control Function) unit, a terminal 54, and the authorizing/charging unit 24 containing an online-charging function (OSC) for online charging and a Charging-Collection Function (CCF) for offline charging.

The terminal 50 operates according to the SIP protocol and serves to transmit multimedia data (for example audio and video data), in particular voice data, in the data packet transmission network 10, for example in the internet or in 3GPP networks. The connection control unit 52 likewise operates according to the SIP protocol and serves to control the connection during the transmission of data to and from the terminal 50.

The terminal 54 also serves to transmit voice or, as the case may be, multimedia data. In place of the terminal it is also possible to use an application server 54 which likewise operates according to the SIP protocol (RFC3261) and makes a service available, for example the viewing, purchasing, or hiring of videos. In another exemplary embodiment a Multimedia Resource Function Control (MRFC) unit or, as the case may be, an MRF is used in place of the application server 54.

The A subscriber wishes at a time t0 to set up a connection from his/her terminal 50 to the B subscriber's terminal 54 in order to telephone. An INVITE message 60 is for this purpose generated in the terminal 50 and transmitted to the control unit 52. The control unit 52 processes the INVITE message according to the SIP protocol. At a time t1 the control unit 52 sends an SIP-INVITE message 61 to the terminal 54. The SIP messages 61, 76, and 94 can also be routed to the terminal 54 over a plurality of control units 52.

At a time t2 the control unit 52 sends an authorizing-request message 62 to the authorizing/charging unit 24. The message 62 is addressed in the Diameter Protocol. However, the content of the message 62 depends on the application. In the exemplary embodiment the message 62 contains, inter alia:
a Session ID uniquely identifying the signaling connection requiring to be set up, and
a user identifier uniquely identifying the A subscriber,
the required service, and
where applicable, a required payment type if the payment type is not already apparent from the service.

The INVITE message 60 is thus the triggering point for authorizing or, as the case may be, preparing for charging.

The message 62 is processed by the authorizing/charging unit 24, during which a check is carried out to determine whether the A subscriber is authorized, see procedural step 64. That is the case in the exemplary embodiment. The type of charging, for example prepaid, is therefore specified in a following procedural step 66. A check is carried out in a procedural step 68 to determine whether the A subscriber's credit has a minimum value. A minimum sum, for example for the “voice telephony” service, is reserved in an ensuing procedural step 70.

At a time t4 an authorizing-answer message 72 is then generated which in the exemplary embodiment contains, inter alia, the following data fields or, as the case may be, AVPs (Attribute Value Pairs):
Session ID,
Duration of authorization,
State of authorization session.

The message 72 is transmitted by the network element having the authorizing/charging unit 24 to the control unit 52 and processed there. According to the Diameter Protocol the requested service is permitted.

The INVITE message 61 is processed in the application server 54 according to the SIP protocol and responded to with an acknowledgment message 76 at a time t8. Said acknowledgment message 76 is referred to also as a 2000K message. The acknowledgment message 76 is transmitted from the application server 54 to the control unit 52. After receiving the acknowledgment message 76 the control unit 76 generates an acknowledgment message 78 toward the terminal 50 at a time t10 according to the SIP protocol.

An SIP session 80 has thereafter been set up between the terminal 50 and the application server 54. Inter alia voice data is transmitted between the terminals 50 and 54 over a UDP (User Datagram Protocol) connection or RTP (Real Time Protocol) connection. The connection, belonging to the SIP session 80, for transmitting useful data has a Call ID (identifier) that has to be correlated with the Session ID indicated in the message 62.

At a time t12 the control unit 52 sends a Diameter charging-request message 82 to the authorizing/charging unit 24 after the SIP session 80 or, as the case may be, the connection for transmitting useful data (RTP/UDP) has been set up. The message 82 is referred to also as an accounting-request message. The message 82 contains, inter alia:
the Session ID, and
the Accounting-Record-Type Event_Record.

The message 82 is processed by the authorizing/charging unit 24, with a timer for budget checking being started in a procedural step 84. A Diameter charging-answer message 86 is also sent to the control unit 52 by the authorizing/charging unit 24 at a time t14. The message 86 likewise contains, inter alia, the Session ID.

The control unit 52 processes the message 86 and permits transmission of the voice data.

The subscriber A terminates the call at a time t18, with an end message 92 being generated in his/her terminal 50 and sent to the control unit 52. On the basis of the message 92 the control unit 52 generates a session-end-request message 90, which is referred to according to the Diameter Protocol also as a session-termination-request (STR) message and has actually not been provided for terminating charging.

In the exemplary embodiment explained the message 90 is nonetheless sent to the authorizing/charging unit 24 and used there for terminating charging. That is because the charging timer is stopped on the basis of the message 90 and a possibly present remaining credit amount credited to subscriber A's account.

At a time t20 the control unit 52 generates an end message 94 according to the SIP protocol. Said end message 94 is transmitted to the terminal 54 and processed there according to the SIP protocol. The SIP session is terminated in a following procedural step 96.

When the charging timer has been stopped, at a time t22 the authorizing/charging unit 24 sends a session-end-answer message 98, which is referred to also as a session-termination-answer (STA) message and, according to the Diameter Protocol, is used only as part of de-authorizing and not, as here, also in connection with the end of charging.

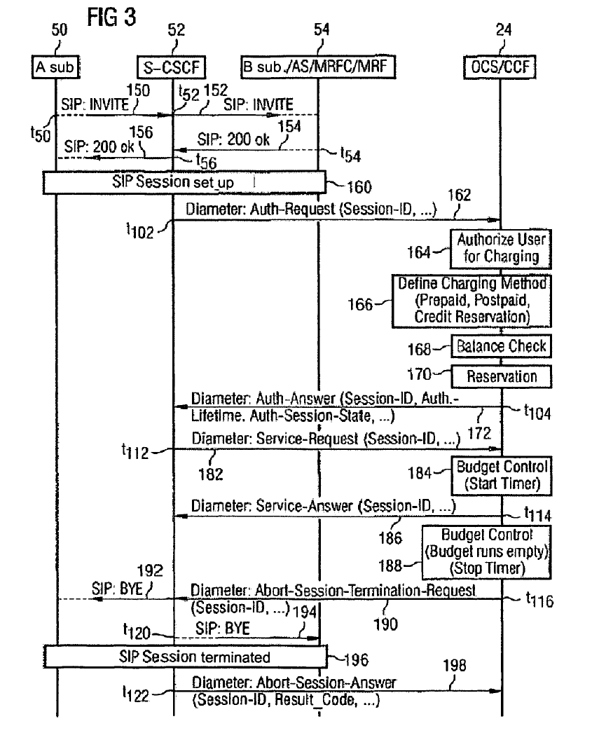

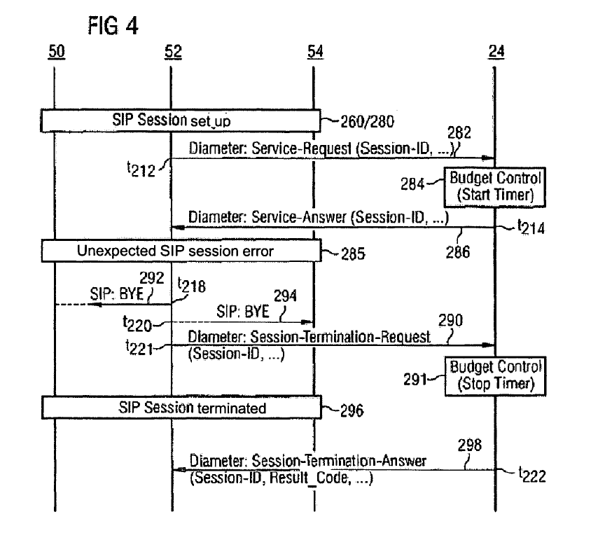

In another exemplary embodiment the method explained with the aid of FIG. 2 is terminated in the manner explained below for the FIGS. 3 and 4.

FIG. 3 shows the flow of messages for an SIP session with online charging (prepaid), with authorizing after setting up of the possibility of transmitting data, and with releasing by a charging computer.

The A subscriber wishes at a time t50 to set up a connection from his/her terminal 50 to the B subscriber's terminal 54 in order to telephone. An INVITE message 150 is for this purpose generated in the terminal 50 and transmitted to the control unit 52. The control unit 52 processes the INVITE message according to the SIP protocol. At a time t52 the control unit 52 sends an SIP-INVITE message 152 to the terminal 54. The terminal 54 processes the message 152 according to the SIP Protocol and, at a time t54, sends an acknowledgment message 154, which is referred to also as a 2000K message. The acknowledgment message 154 is transmitted from the terminal 54 to the control unit 52. At a time t56, after receiving the acknowledgment message 154, the control unit 52 generates an acknowledgment message 156 for the terminal 50 according to the SIP protocol.

An SIP session 80 has thereafter been set up between the terminal 54 and the terminal 54. Inter alia voice data is also transmitted between the terminals 50 and 54. The SIP session 80 has a Session ID (identifier), which is needed in the following.

The control unit 52 sends an authorizing-request message 162 to the authorizing/charging unit 24 at a time t102. The message 162 corresponds to the message 62. Thus in contrast to FIG. 2 not an INVITE message but the acknowledgment message 154 serves as the triggering point for authorizing or, as the case may be, preparing for charging.

The message 162 is processed by the authorizing/charging unit 24, during which a check is carried out to determine whether the A subscriber is authorized, see procedural step 164. That is the case in the exemplary embodiment. The type of charging, for example prepaid, is therefore specified in a following procedural step 166. A check is carried out in a procedural step 168 to determine whether the A subscriber's credit has a minimum value. A minimum sum, for example for the “voice telephony” service, is reserved in an ensuing procedural step 170.

An authorizing-answer message 172 corresponding to the message 72 is then generated at a time t104.

The message 172 is transmitted by the network element having the authorizing/charging unit 24 to the control unit 52 and processed there. According to the Diameter Protocol the requested service is permitted.

When the message 172 has been processed the control unit 52 sends a Diameter charging-request message 182 to the authorizing/charging unit 24 at a time t112. The message 182 corresponds to the message 82. Since the messages mutually correspond, they have the same data fields and same functions.

The message 182 is processed by the authorizing/charging unit 24, with a timer for budget checking being started in a procedural step 184. A Diameter charging-answer message 186 is also sent to the control unit 52 by the authorizing/charging unit 24 at a time t114. The message 186 likewise contains, inter alia, the Session ID.

The control unit 52 processes the message 186 and permits transmission of the voice data.

The budget timer times out at a certain time, see procedural step 188. For example, the budget allowed the subscriber A has been used up. At a time t116 the authorizing/charging unit 24 then generates a Diameter abort-session-request (ASR) message 190. The message 190 likewise contains, inter alia, the Session ID and is transmitted to the control unit 52.

At a time t118, on the basis of the message 190 the control unit 52 generates an end message 192 for the terminal 50 according to the SIP protocol. The end message 192 is referred to also as a BYE message. On the basis of the message 190 the control unit 52 also generates an SIP end message 194 for the terminal 54 at a following time t120. Receipt of the message 190 is thus the criterion for releasing the SIP session on both sides.

The SIP session is terminated on the basis of the end messages 192 and 194, see procedural step 196. At a time t122 the control unit 52 then generates a Diameter abort-session-answer (ASA) message 98. The message 198 is transmitted to the authorizing/charging unit 24 and processed there according to the Diameter Protocol. The message 198 contains, inter alia:
the Session ID, and
a result code.

In another exemplary embodiment the SIP session is terminated according to FIG. 2 or, as the case may be, FIG. 3.

The choice of triggering points according to FIG. 1 or, as the case may be, FIG. 2 is independent of the charging method or, as the case may be, aborting method, prepaid or postpaid.

FIG. 4 shows a part of the flow of messages in an SIP session with online charging (prepaid), with releasing by a control unit for controlling the transmission of data.

Up to procedural step 260 the part of the method proceeding as far as procedural step 160 is executed according to FIG. 3. Alternatively, up to a procedural step 280 corresponding to procedural step 280 the part of the method proceeding as far as procedural step 80 is executed according to FIG. 2. The preparations for data transmission as part of an SIP session are therefore completed at procedural step 260 or, as the case may be, 280.

A message 282 corresponding to the message 82 or, as the case may be, 182 is generated by the control unit at a time t212 following procedural step 260 or, as the case may be, 280. The charging timer (timer) is started while the message 282 is being processed in the unit 24. A message 286 corresponding to the message 86 or, as the case may be, 186 is then generated.

An unexpected SIP session error 285 occurs after the message 286 has been received and processed. The following unexpected SIP session errors are possible, for example:
operator blocks the A subscriber via the Cx interface provided between the HSS (Home Subscriber Server) and S-CSCF according to the standard, or
authentication is defective.

On the basis of the SIP session error 285 the control unit 52 sends an SIP end message 292 to the terminal 50 at a time t218 and an SIP end message 294 to the terminal 54 at a time t220. The SIP session is then terminated at a procedural step 296 based on the two messages 292 and 294.

In connection with terminating, an abort-session-request message 290 is sent to the authorizing/charging unit 24 by the control unit 52 at a time t221. The message 290 corresponds to the message 90. On the basis of the message 290 the authorizing/charging unit 24 stops the charging timer in a procedural step 291. At a time t222 the authorizing/charging unit 24 then sends a session-termination-answer message 298 corresponding to the message 98 to the control unit 52.

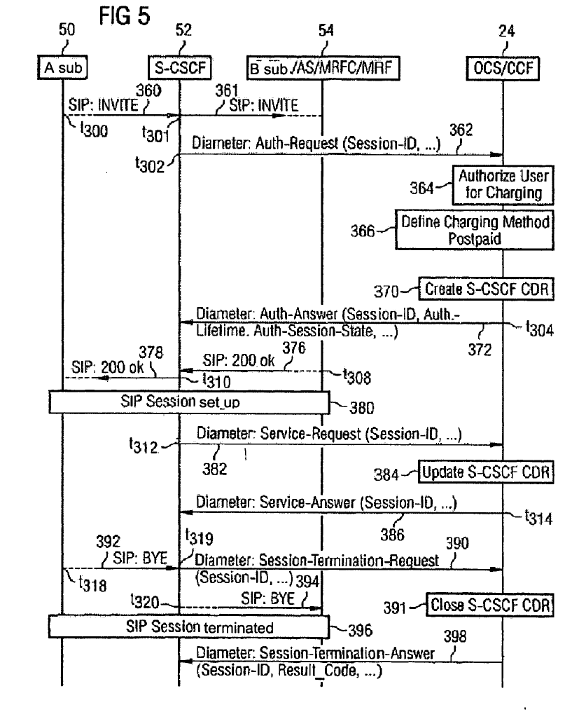

FIG. 5 shows the flow of messages in an SIP session with offline charging. Except for the departures explained below, the same messages are transmitted and processed in the same way as explained above with the aid of FIG. 2. The same times and messages are therefore referenced in the same way, with the times and messages according to FIG. 5 being prefixed with a 3 to distinguish them.

The differences relate to the following procedural steps:
At procedural step 366, which is carried out in place of procedural step 66, it is recognized from the user identifier and/or the service that offline charging is to be performed that is invoiced using a postpaid method.
Procedural step 68 relating to balance checking is omitted and so has no corresponding procedural step.
At procedural step 370 a charge-data record, referred to as an S-CSCF CDR (Charging Data Record), is generated in place of reserving. A charge-data record of said type is explained in more detail in, for example, the 3GPP TS 32.225 standard.
At procedural step 384 the CDR data record is changed according to the message 382.
At procedural step 391 the CDR data record is properly filed, or, as the case may be, closed.

From the viewpoint of the control unit 52 the charging method does not need to be known so that, except for the cited differences, the flow is the same as that carried out in FIG. 2.

FIG. 6 shows a server unit 400 which performs the functions of the authorizing/charging unit 24 and contains the following units:
a storage unit 402,
a sending/receiving unit 404 which can receive the authorizing messages 62, 162, 262, and 362 as well as the charging messages 82, 182, 282, and 282,
a charging unit 406 which changes charging data depending on the content of the charging messages 82, 182, 282 or, as the case may be, 282, and
an authorizing unit which performs authorizing after receiving the authorizing message 62, 162, 262 or, as the case may be, 362, see procedural step 64, 164, 264 or, as the case may be, 364.

The server unit 100 contains, where applicable, further units 410 for implementing the methods explained above with the aid of FIGS. 2 to 5.

In an exemplary embodiment all the units 404 to 410 access the memory 402 in order to perform their functions, see arrow 414. The charging unit 406 and the authorizing unit 408 work together especially closely, particularly during the execution of procedural steps 66 to 70 and 166 to 170 or, as the case may be, during execution of procedural steps 366 and 370.

In a first alternative the server unit 400 does not contain a processor processing a program. The units 404 to 410 contain circuits that are permanently wired. In an alternative variant the functions of the units 404 to 410 are, however, provided by a processor 416, with a program being processed that is stored in the memory 102.

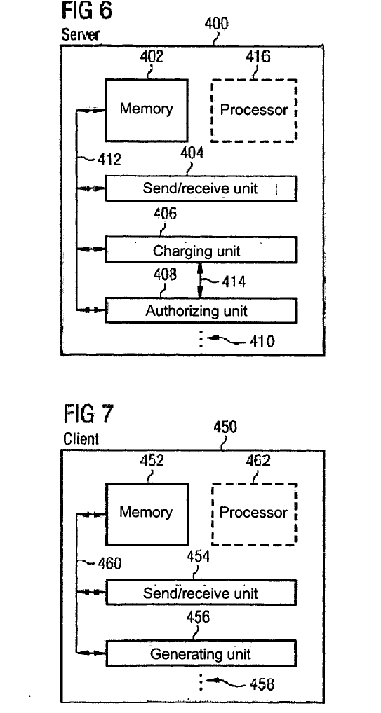

FIG. 7 shows functional units of a client unit 450 that operates in conjunction with the server unit 400 using the methods explained with the aid of FIGS. 2 to 5. The client unit 450 contains:
a storage unit 452 for storing data records,
a sending/receiving unit 454 for sending the messages 62, 162, 262, 362, 82, 182, 282, 382, 90, 290, and 390, and
a generating unit 456 which can generate the messages just cited.

The generating unit 456 accesses the same data record in the storage unit 452 when the authorizing message is being generated and when the charging message is being generated.

The client unit 450 contains, where applicable, further units 458 in order to perform the functions for authorizing and charging, in particular a receiving unit for receiving the answer messages, or, as the case may be, the message 190.

In an exemplary embodiment all the units 454 to 458 access the memory 452 in order to perform their functions, see arrow 460.

In a first alternative the client unit 450 does not contain a processor processing a program. The units 454 to 458 contain circuits that are permanently wired. In an alternative variant the functions of the units 454 to 456 are, however, provided by a processor 462, with a program being processed that is stored in the memory 452.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-18. (canceled)

19. A method for charging, comprising:
storing in a network element of a data transmission network a charge-data record having charge data indicating an account balance of a charge account of a user;
transmitting a service request message from a user, the service request message requesting an amount of use of a service;
allocating service termination data to the user based on the amount of use requested, the service termination data specifying a limit on the use of the service, the service termination data being stored in the network element;
changing the charge data based the allocation of service termination data;
changing the service termination data as the user uses the service; and
determining an end of the service based on the service termination data in the network element.

20. The method according to claim 19, wherein
the service termination data specifies a length of time for which the user can use the service, or
the service termination data specifies a maximum volume of data allowed to be transmitted over the data transmission network while the service is in use.

21. The method according to claim 19, further comprising:
generating an authorizing message according to an authorizing protocol or according to an authorizing portion of a protocol;
transmitting the authorizing message over the data transmission network; and
using the authorizing message to prepare for charging or using the authorizing message to control termination of charging.

22. The method according to claim 21, wherein
the authorizing message contains a user identifier indicating the user of the data transmission,
authorization for the user to transmit data is checked as a function of the user identifier, and
a type of charging and/or of invoicing is selected based on the authorizing message.

23. The method according to claim 21, wherein
a charging amount or charging time is reserved based on the authorizing message, and/or
a charge-data record for charging is generated while the authorizing message is being processed.

24. The method according to claim 21, wherein
the authorizing message is transmitted prior to completing preparation for data transmission.

25. The method according to claim 21, wherein
the authorizing message is transmitted after completing preparation for data transmission.

26. The method according to claim 21, wherein
the authorizing message complies with the specifications of the Diameter Protocol or a protocol based thereon, and/or
the authorizing message is processed according to the Diameter Protocol or a protocol based thereon.

27. The method according to claim 21, wherein
the authorizing message is employed upon termination, and
the authorization message is an abort-session-request-message of the Diameter Protocol or of a protocol based thereon.

28. The method according to claim 19, wherein
before the service request message is transmitted, a pre-service request message is transmitted containing a user identifier identifying the user of the service,
authorization of the user to transmit data is checked as a function of the pre-service request message, and
a type of charging and/or of invoicing is selected on the basis of the service request message.

29. The method according to claim 28, wherein
the service request message and the pre-service request message are messages according to the Diameter Base Protocol or a protocol based thereon.

30. The method according to claim 28, wherein
a termination message is transmitted by the network element, and
said termination message is an expansion of a charging part of the Diameter Base Protocol.

31. The method according to claim 28, wherein
the pre-service request message is transmitted prior to completing preparation for data transmission.

32. The method according to claim 28, wherein
the pre-service request message is transmitted after completion for preparation for data transmission.

33. The method according to19, wherein
charging is online charging able to influence the transmission of data, and
charging is monitored in a service-performing computer provided in addition to a service-performing computer that controls transmission of data.

34. The method according to claim 19, wherein
the same service request message is transmitted for online charging and for offline charging, and
the service request message is an account-request message according to the Diameter Protocol or a protocol based thereon, with the same Account-Record Type is used in both service request messages.

35. A charging unit comprising:
a receiving unit to receive a service request message from a data transmission network, the service request message requesting a service and containing an access identifier identifying a data transmission in the data transmission network;
a charging unit which, as a function of the service request message, performs charging for the data transmission with the charging unit allocating service termination data to the user based on an amount of use requested, the service termination data specifying a limit on the use of the service, the charging unit debiting a charge account of the user based on the allocation of service termination data, the charging unit changing the service termination data as the user uses the service and determining an end of the service based on the service termination data.

36. The charging unit according to claim 35, further comprising an authorizing unit which receives or sends an authorizing message according to an authorizing protocol or an authorizing portion of a protocol and uses the authorizing message to prepare for charging and on termination of charging.

37. A client charging unit comprising:
a sending unit for sending a service request message,
with the service request message containing an access identifier identifying a data transmission in the data transmission network, the service request message requesting an amount of use of a service and causing an allocation of service termination data to the user based on the amount of use requested, the service termination data specifying a limit on the use of the service, the user having a charge account that is debited based on the allocation of service termination data, the service termination data being changed as the user uses the service, the service termination data being used to determine a termination point for the service.

38. A charging unit according to claim 35, wherein
the charging unit receives and/or sends messages according to the Diameter Base Protocol.
